(19) United States
(12) Patent Application Publication
(10) Pub. No.: US 2007/0071139 A1
(43) Pub. Date: Mar. 29, 2007

(54) Channel decoding using hard and soft decisions

(76) Inventors: Guner Arslan, Austin, TX (US); Marvin Vis, Boulder, CO (US); Shaojie Chen, Austin, TX (US)

Correspondence Address: TROP PRUNER & HU, PC, 1616 S. VOSS ROAD, SUITE 750, HOUSTON, TX, 77057-2631, US

(21) Appl. No.: 11/234,517

(22) Filed: Sep. 23, 2005

(51) Int. Cl. H04L 27/06; H04B 14/04

(52) U.S. Cl. 375/340; 375/242

(57) ABSTRACT

In one embodiment, the present invention includes a method for receiving channel data via a transmission channel, generating hard and soft decisions for each bit of the channel data in an equalizer, and storing the hard decisions in a first buffer and storing the soft decisions in a second buffer. Each of the soft decisions may be quantized before their storage, while the hard decisions may be generated based on a corresponding unquantized soft decision. Other embodiments are described and claimed.

### FIELD OF THE INVENTION

The present invention relates to data processing and more particularly to data processing in a communication device.

### BACKGROUND

Virtually all systems perform communications, either internally and/or externally between different systems. Wireless devices or mobile stations such as cellular handsets and other wireless systems transmit and receive radio frequency (RF) information including representations of speech waveforms. A physical layer of a cellular handset typically includes circuitry for performing two major functions, namely encoding and decoding. This circuitry includes a channel codec for performing channel encoding and decoding functions and a vocoder for performing voice encoding and decoding functions. The vocoder performs source encoding and decoding on speech waveforms. Source coding removes redundancy from the waveform and reduces the bandwidth (or equivalently the bit-rate) in order to transmit the waveform in real-time. The channel codec increases redundancy in the transmitted signal to enhance the robustness of the transmitted signal.

A number of different wireless protocols exist. One common protocol is referred to as global system for mobile communications (GSM). Typical GSM and other communications systems that employ error correction coding such as forward error correction (FEC) generally use a two-stage receiver architecture having an equalizer and a decoder. The function of the equalizer is to compensate for adverse channel effects, while the function of the decoder is to recover original data bits from the encoded sequence. It is also common practice to employ an interleaving scheme to avoid large gaps in the received data if the channel conditions degrade temporarily. After deinterleaving, degraded data symbols are spread amongst a large number of reliable symbols, allowing the decoder a chance to correctly decode the degraded symbols. In many applications, data are transmitted and received in finite-length packets or bursts. Interleaving in such systems is done over multiple bursts, and hence decoding occurs after a certain number of bursts have been received. For example, in a GSM system data are interleaved over a range of 2 to 22 bursts depending on the logical channel in use. The equalizer, on the other hand, generally works on each burst separately.

Because FEC adds redundancy to payload data, in some communication systems such coding is only applied to the most important data (e.g., bits). For optimal performance, an equalizer provides a decoder with “soft decisions” rather “hard decisions” or bits. A soft decision carries information about what the received bit is and a reliability number for the bit. The soft decisions from each burst are stored in a buffer until enough data are available for the decoder to operate. One design parameter in a system that employs FEC is the precision (e.g., number of bits) to be used for storing the soft information. This parameter is a tradeoff between performance increases with an increasing number of bits and increased cost of storing larger numbers of bits per soft metric.

Another design parameter is the format of the soft metrics. Two common formats used to represent soft metrics are 1's and 2's complement numbers. Because most programmable processors use 2's complement arithmetic, if the soft metrics are in 1's complement representation, additional pre-processing to convert numbers to 2's complement is done before performing arithmetic operations. This conversion process may be repeated several times for each soft metric, which increases complexity. If instead 2's complement representation is used, which has only one representation for zero, a bias may occur when slicing (i.e, processing) low precision 2's complement soft metrics to obtain uncoded bits. In other words, 2's complement representation loses the distinction between 0− and 0+ that is maintained by a 1's complement representation. This loss in resolution is equivalent to an offset bias (referred to as a bias problem or a bias effect) in the soft metrics for uncoded bits, which will cause degradation in bit error rate (BER) performance on the uncoded bits. These two design parameters (i.e., precision and format of soft decisions) thus lead to tradeoffs that are not ideal for any system.

### SUMMARY OF THE INVENTION

In one embodiment, the present invention includes a method for receiving channel data via a transmission channel, generating a hard decision and a soft decision for each bit of the channel data in an equalizer, and storing the hard decisions in a first buffer and storing the soft decisions in a second buffer. Each of the soft decisions may be quantized before their storage, while the hard decisions may be generated based on a corresponding unquantized soft decision. Using these hard and soft decisions, the channel data may be decoded in one of a number of different manners, depending on a type of data received.

Other embodiments may be implemented in an apparatus, such as an integrated circuit (IC). The IC may include an equalizer to generate hard decisions and soft decisions for incoming data, a first buffer to store the hard decisions, and a second buffer to store the soft decisions. The equalizer may generate the hard decisions from corresponding unquantized soft decisions, where the soft decisions are in a 2's complement representation. The IC may further include a decoder coupled to the equalizer to decode the incoming data based on the hard decisions and the soft decisions. As an example, the IC may take the form of a digital signal processor (DSP), and the buffers may be implemented in a storage of the DSP.

Embodiments of the present invention may be implemented in appropriate hardware, firmware, and software. To that end, a method may be implemented in hardware, software and/or firmware to handle decoding of data, e.g., of a wireless device via hard and soft decisions. The method may perform various functions including determining a soft decision for each incoming baseband data and determining a corresponding hard decision from the soft decision, and decoding at least one of the hard decision and the soft decision for each of the baseband data to generate a symbol corresponding to the baseband data. In some implementations, only a single one of the hard decision and the soft decision may be decoded, while in other implementations both decisions may be decoded, at least for certain types of data.

In one embodiment, a system in accordance with an embodiment of the present invention may be a wireless device such as a cellular telephone handset, personal digital assistant (PDA) or other mobile device. Such a system may include a transceiver, as well as digital circuitry. The digital circuitry may include circuitry such as an IC that includes at least some of the above-described hardware, as well as control logic to implement the above-described methods.

### BRIEF DESCRIPTION OF THE DRAWINGS

FIG. 1 is a block diagram of an audio signal processing path in a wireless device in accordance with an embodiment of the present invention.

FIG. 2 is a flow diagram of a method in accordance with one embodiment of the present invention.

FIG. 3 is a block diagram of a buffer system in accordance with an embodiment of the present invention.

FIG. 4 is a block diagram of a buffer system in accordance with another embodiment of the present invention.

FIG. 5 is a flow diagram of a decoding method in accordance with one embodiment of the present invention.

FIG. 6 is a block diagram of a system in accordance with one embodiment of the present invention.

### DETAILED DESCRIPTION

In various embodiments, an equalizer may generate both hard decisions and soft decisions for all received data. Further, the soft decisions may be stored in a 2's complement format, thus avoiding conversion before every arithmetic operation. The hard decisions may be generated before the corresponding soft decisions are quantized for storage, avoiding the bias problem. In other words, the equalizer may obtain hard decisions by slicing high precision (e.g., 16 bit) 2's complement soft metrics. An equalizer in accordance with one embodiment may be used in various communication systems including wireless devices, wired devices, and even within a single data processing system such as between discrete components of a computer system, among many other systems.

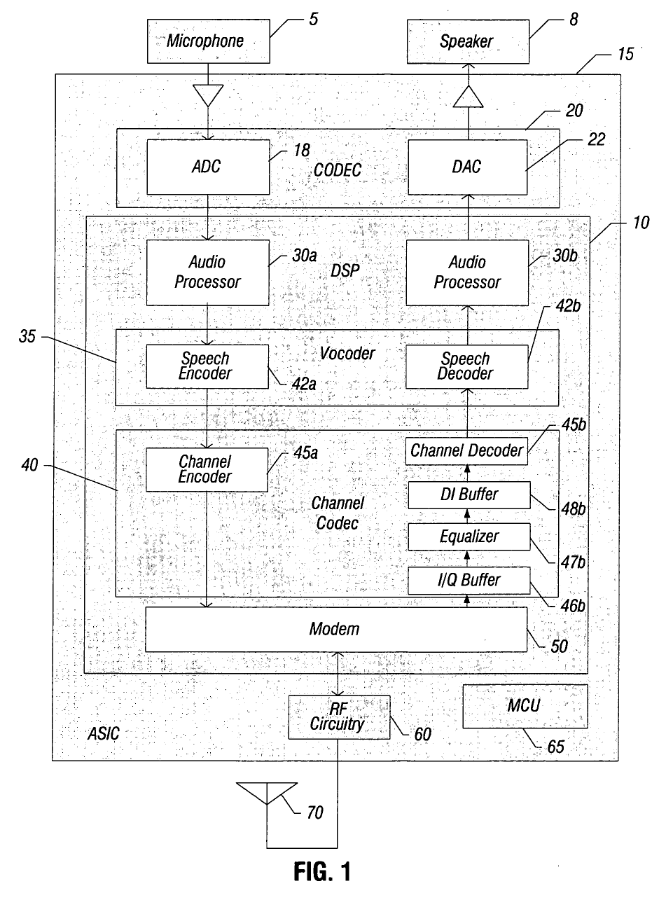

Referring to FIG. 1, shown is a block diagram of a signal processing path in a wireless device in accordance with an embodiment of the present invention. Such a transmission chain may take the form of multiple components within a cellular handset or other mobile station, for example. As shown in FIG. 1, an application specific integrated circuit (ASIC) 15 may include both baseband and radio frequency (RF) circuitry. The baseband circuitry may include a digital signal processor (DSP) 10. DSP 10 may process incoming and outgoing audio samples in accordance with various algorithms for filtering, coding, equalization, and the like.

While shown as including a number of particular components in the embodiment of FIG. 1, it is to be understood that DSP 10 may include additional components and similarly, some portions of DSP 10 shown in FIG. 1 may instead be accommodated outside of DSP 10. It is also to be understood that DSP 10 may be implemented as one or more processing units to perform the various functions shown in FIG. 1 under software control. That is, the functionality of the different components shown within DSP 10 may be performed by common hardware of the DSP according to one or more software routines. As further shown in FIG. 1, ASIC 15 may further include a microcontroller unit (MCU) 65. MCU 65 may be adapted to execute control applications and handle other functions of ASIC 15.

DSP 10 may be adapted to perform various signal processing functions on audio data. While discussed in the context of audio processing, other data may also be processed by the embodiment of FIG. 1. In an uplink direction, DSP 10 may receive incoming voice information, for example, from a microphone 5 of the handset and process the voice information for an uplink transmission. This incoming audio data may be converted from an analog signal into a digital format using a codec 20 formed of an analog-to-digital converter (ADC) 18 and a digital-to-analog converter (DAC) 22, although only ADC 18 is used in the uplink direction. In some embodiments, the analog voice information may be sampled at 8,000 samples per second (S/s). The digitized sampled data may be stored in a temporary storage medium (not shown in FIG. 1). In some embodiments, one or more such buffers may be present in each of an uplink and downlink direction for temporary sample storage.

The audio samples may be collected and stored in the buffer until a complete data frame is stored. While the size of such a data frame may vary, in embodiments used in a time division multiple access (TDMA) system, a data frame (also referred to as a “speech frame”) may correspond to 20 ms of real-time speech (e.g., corresponding to 160 speech samples). In various embodiments, the input buffer may hold 20 ms or more of speech data from ADC 18. As will be described further below, an output buffer (not shown in FIG. 1) may hold 20 ms or more of speech data to be conveyed to DAC 22.

The buffered data samples may be provided to an audio processor 30a for further processing, such as equalization, volume control, fading, echo suppression, echo cancellation, noise suppression, automatic gain control (AGC); and the like. From front-end processor 30a, data are provided to a vocoder 35 for encoding and compression. As shown in FIG. 1, vocoder 35 may include a speech encoder 42a in the uplink direction and a speech decoder 42b in a downlink direction. Vocoder 35 then passes the data to a channel codec 40 including a channel encoder 45a in the uplink direction and a channel decoder 45b in the downlink direction. From channel encoder 45a, data may be passed to a modem 50 for modulation. The modulated data is then provided to RF circuitry 60, which may be a transceiver including both receive and transmit functions to take the modulated baseband signals from modem 50 and convert them to a desired RF frequency (and vice versa). From there, the RF signals including the modulated data are transmitted from the handset via an antenna 70.

In the downlink direction, incoming RF signals may be received by antenna 70 and provided to RF circuitry 60 for conversion to baseband signals. The transmission chain then occurs in reverse such that the modulated baseband signals are coupled through components of the downlink direction. As shown in FIG. 1, demodulated baseband signals (i.e., in-phase (I) and quadrature-phase (Q) signals) are provided to an I/Q buffer 46b for intermediate storage. When a complete burst (e.g., a single frame of data) is received in I/Q buffer 46b, the baseband data is provided to an equalizer 47b, which is used to remove transmission channel characteristics from the data. After equalization, the data which may be in the form of both hard decisions and soft decisions corresponding to the received data, is stored in a plurality of deinterleave (DI) buffers 48b. As will be discussed further below, buffers 48b may include at least a first buffer and a second buffer. These buffers may be adapted to store soft decisions and hard decisions, respectively. However in many embodiments multiple first (e.g., soft decision) buffers and multiple second (e.g., hard decision) buffers may be present.

When sufficient data is stored in DI buffers 48b, e.g., corresponding to a number of data bursts, the data may be provided to channel decoder 45b of codec 40. Channel decoder 45b may deinterleave the data from buffers 48b and perform decoding, for example, FEC decoding. The channel coded data is then provided to a speech decoder 42b of vocoder 35, and then in turn to an audio processor 30b, and DAC 22 (via a buffer, in some embodiments) to obtain analog audio data that is coupled to, for example, a speaker 8 of the handset.

For purposes of further illustration, the discussion is with respect to a representative GSM/general packet radio service (GPRS)/EDGE/TDMA system (generally a “GSM system”). However, other protocols may implement the methods and apparatus disclosed herein, particularly where data received by a system or a component of such a system is coded, for example, FEC-coded.

A GSM system makes use of a TDMA technique, in which each frequency channel is further subdivided into eight different time slots numbered from 0 to 7. Each of the eight time slots may be assigned to an individual user in GSM system, while multiple slots can be assigned to one user in a GPRS/EDGE system. A set of eight time slots is referred to herein as a TDMA frame, and may be a length of 4.615 ms. A 26-multiframe is used as a traffic channel frame structure for the representative system. The total length of a 26-frame structure is 26*4.615 ms=120 msec. In a GSM system, a speech frame is 20 msec while a radio block is 4 TDMA frames, which is 4*4.615=18.46 msec. Thus every three radio blocks the TDMA frame or radio block boundary and the speech frame boundaries are aligned.

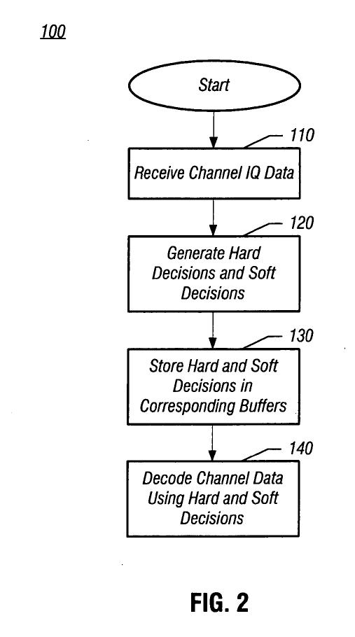

Referring now to FIG. 2, shown is a flow diagram of a method in accordance with one embodiment of the present invention. As shown in FIG. 2, method 100 may be used to process incoming data, for example, of a transmission channel that sends data using a coding scheme, such as FEC. Method 100 may begin by receiving channel data (block 110). For example, in the context of a wireless system RF signals may be received, downconverted to a baseband frequency and demodulated into I and Q baseband data. In other embodiments, for example, communication between devices of a single system, a wired transmission channel may be used to receive equalized or other encoded data from a sending device.

Still referring to FIG. 2, next hard and soft decisions may be generated for the channel data (block 120). As an example, an equalizer may process the received channel data to determine the level (e.g., logic 1or logic 0) of incoming bits as both a hard decision and a soft decision. These hard and soft decisions may correspond to a determined value for the bit and a reliability metric for the determination, respectively. The equalizer may make the hard and soft decisions based on, e.g., the strength of received bits. In one embodiment, the equalizer may first determine a soft decision with a high precision. For example, a sixteen-bit soft metric may be determined. In various embodiments, the sixteen-bit soft decision may have a most significant bit (MSB) corresponding to an actual decision for a received bit (e.g., a zero or one) and up to fifteen bits corresponding to a reliability factor for the bit, with a larger value of the reliability factor indicative of a greater reliability for the corresponding MSB. In various embodiments, the hard decision may be taken from the MSB itself. In other words, the MSB of the soft decision is the hard decision for the received bit. In this manner, hard decisions may be obtained before the corresponding soft decision is quantized for storage. Accordingly, concerns related to the bias effect discussed above may be avoided.

Still referring to FIG. 2, next the hard and soft decisions may be stored in corresponding buffers (block 130). That is, the hard decision may be stored in one buffer while the soft decision corresponding thereto may be stored in a second buffer. In some implementations, the hard decisions each may be a single bit corresponding to a hard value for a received bit, while the corresponding soft decision may be, for example, a four-bit value that corresponds to a 2's complement representation of a reliability metric for the determined bit value. Thus, in many embodiments a high precision soft metric may be quantized to a lower precision value for storage into the second buffer. For example, a sixteen-bit soft metric may be quantized into a corresponding four-bit value for storage. Also, both the high resolution soft metric and the lower resolution soft metric may be in a 2's complement representation. By providing the soft metric in a 2's complement representation, additional expense in later converting 1's complement representation into 2's complement representation may be avoided. Furthermore, a reduced number of bits (i.e., a lower resolution soft metric) may be stored, as the hard decision is generated prior to quantization.

Shown in Table 1 below are different representations of four-bit reliability metrics.

TABLE 1

| 1's Complement | 2's Complement | Decimal |
|---|---|---|
| NA | 1000 | −8 |
| 1000 | 1001 | −7 |
| 1001 | 1010 | −6 |
| 1010 | 1011 | −5 |
| 1011 | 1100 | −4 |
| 1100 | 1101 | −3 |
| 1101 | 1110 | −2 |
| 1110 | 1111 | −1 |
| 1111 | NA | −0 |
| 0000 | 0000 | +0 |
| 0001 | 0001 | +1 |
| 0010 | 0010 | +2 |
| 0011 | 0011 | +3 |
| 0100 | 0100 | +4 |
| 0101 | 0101 | +5 |
| 0110 | 0110 | +6 |
| 0111 | 0111 | +7 |

As shown in Table 1, each of a 1's complement, 2's complement and decimal representation of reliability factors, i.e., soft metrics are shown. Further as shown in Table 1, the reliability metrics are shown in a descending reliability order for the negative range (i.e., a value of −8 has the greatest reliability, while a value of −0 has the lowest reliability), while the positive range is shown is an ascending reliability (i.e., +7 has the highest reliability value, while +0 has the least reliability). Due to the inherent nature of 1's complement and 2's complement representations, certain reliability values are not available. Specifically, as shown in Table 1, a soft metric of −8 does not have 1's complement representation. Furthermore, a 2's complement representation has no value for a −0 metric reliability measure. Although a 2's complement representation does not have an analog for a negative zero value, a hard decision corresponding to this level may be accurate, as it is generated prior to the quantization value in Table 1. Thus bias errors are

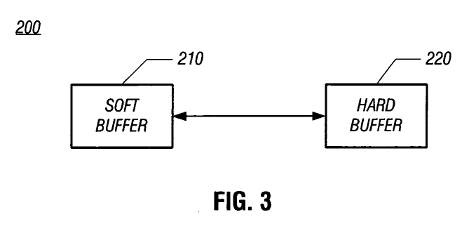

Referring to FIG. 3, shown is a block diagram of a buffer arrangement in accordance with one embodiment of the present invention. As shown in FIG. 3, a buffer system 200, which may correspond to DI buffers 48b of FIG. 1, includes a first buffer 210 and a second buffer 220. As shown in FIG. 3, first buffer 210 may be a soft decision buffer (also referred to herein as a soft buffer), while second buffer 220 may be a hard decision buffer (referred to herein as a hard buffer). While described this way in the embodiment of FIG. 3, in other embodiments, first buffers may be associated with hard decisions and second buffers may be associated with soft decisions. In various implementations, first buffer 210 may be larger, and in many cases substantially larger than second buffer 220. The greater size of first buffer 210 thus provides for storage of soft decisions corresponding to the hard decisions stored in second buffer 220. In one embodiment, first buffer 210 may store 256 words, while second buffer 220 may store 32 words. In various implementations, each word (e.g., 16 bits) stores packed data corresponding to a number of data symbols. As one example, each bit of a 16-bit word of second buffer 220 may store a single bit hard decision corresponding to a transmitted data bit, while four bits of a 16-bit word of first data buffer 210 may store a corresponding soft decision. In such an implementation, therefore, each word of second buffer 220 may store hard decisions for 16 data bits, while each word of first buffer 210 may store soft decisions for four data bits. Buffer system 200 of FIG. 3 may correspond to buffers for speech channels, in one embodiment.

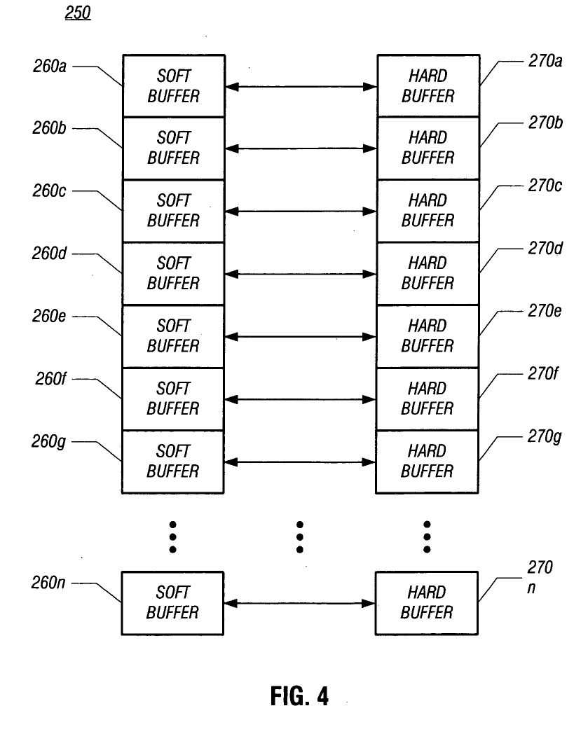

Referring now to FIG. 4, shown is a block diagram of a buffer system in accordance with another embodiment of the present invention. As shown in FIG. 4, buffer system 250 includes a plurality of first buffers 260a-260n and a plurality of corresponding second buffers 270a-270n. While shown with this particular configuration in the embodiment of FIG. 4, it is to be understood that more or fewer first and second buffers may be present in different embodiments. In one embodiment, first buffers 260 (generically) may each include storage for 128 words, while each of second buffers 270 (generically) may include storage for 32 words. In such an embodiment, buffer system 250 may be used for storage of hard and soft decisions for GPRS channels, as an example.

However, other implementations are possible, and in many implementations the size of the soft decision buffer(s) may be substantially larger than the hard decision buffer(s). In the described implementations, the soft buffer may be at least two times greater than the hard decision buffer and more particularly at least four times and even up to sixteen times greater. Furthermore, while described as separate buffers, in some embodiments a single memory may include all of the buffers. For example, with reference back to FIG. 1, DI buffers 48b may all be implemented in a single memory, for example, a memory array of DSP 10.

Although two separate buffers are used for hard and soft decisions, in various implementations memory usage may actually decrease. That is, hard decisions use only 1 bit per symbol and thus may be packed 16 to a word. This minimal memory consumption may be used instead of increased precision of soft metrics, which would consume significantly greater memory.

Finally with reference back to FIG. 2, the channel data may be decoded using the hard and soft decisions (block 140). Different implementations for decoding the data are possible. In one embodiment, a channel decoder may deinterleave data in both buffers to decode the channel data. In other implementations, only a single one of the buffers may be deinterleaved to recover the channel data. For example, where all channel data is encoded, only the soft decision buffer may be deinterleaved. In contrast, where none of the channel data is encoded, only the hard decision buffer may be deinterleaved. Of course, combinations of these deinterleaving schemes may be performed. Furthermore, in many embodiments different deinterleaving schemes may be used, depending upon a type of encoding, error correction and the like.

For example, when the decoder decodes multiple bursts of data, e.g., corresponding to a radio block, the decoder may determine a specific logical channel being used. In other words, the decoder may determine the type of coding, if any, applied to the received data. In some implementations, so-called stealing flags may be decoded to determine a given logical channel. For example, in a GPRS mode, the decoder can determine what logical channel is to be decoded before any deinterleaving is done. Therefore, depending on the logical channel, the decoder may perform only one deinterleave operation from either the soft buffer (e.g., for CS1/2/3 which use FEC) or from the hard buffer (e.g., for CS-4 which is uncoded). Thus, based on a determination of the given logical channel, one or both buffers may be deinterleaved, as will be discussed further below.

In other implementations, e.g., in a GSM system, speech channels may have certain burst portions encoded, while other burst portions are uncoded. For example, in one GSM implementation, full-rate speech may be transmitted in blocks of 260 bits, in which the first 182 bits are considered class one bits and are encoded, while the final 78 bits are class two bits and are not encoded. In such implementations, the soft decision buffer may first be deinterleaved and decoded, and then a portion of the hard buffer corresponding to the uncoded bits may be deinterleaved, thus overwriting the soft decisions for the uncoded bits. Still further, additional data transmitted with voice information, e.g., control information may also be encoded.

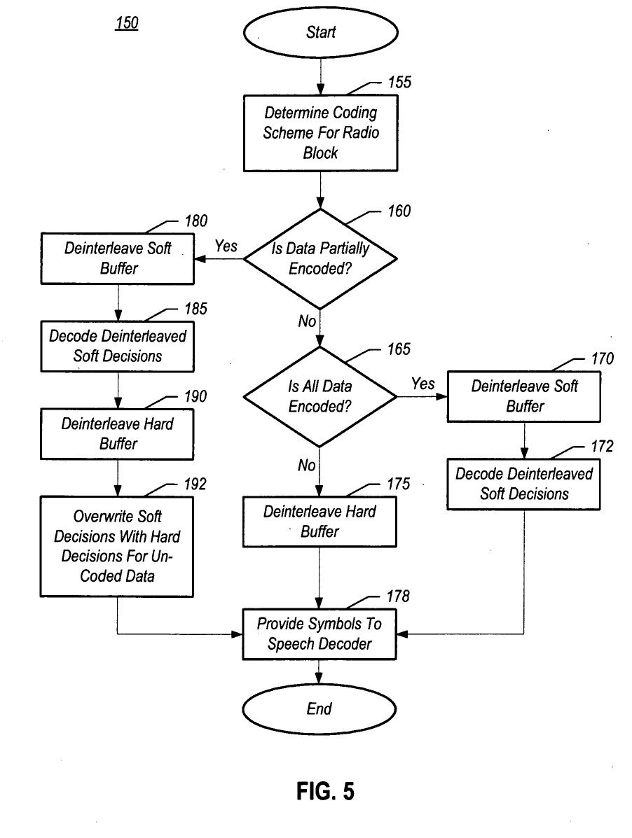

Referring now to FIG. 5, shown is a flow diagram of a decoding method in accordance with one embodiment of the present invention. As shown in FIG. 5, method 150 may begin by determining a coding scheme for a radio block (block 155). For example, the decoder may decode the stealing flags of a communication to determine a logical channel used for an incoming transmission. Based on this determination, it may next be determined whether the data is partially encoded (diamond 160). If not, next it may be determined if all of the data is encoded (diamond 165). If it is determined at diamond 165 that all of the data is encoded, the soft buffer only may be deinterleaved (block 170). Then the deinterleaved soft decisions may be decoded (block 172). For example, a Viterbi decoder may be implemented to perform the decoding. Then the decoded symbols may be provided to, e.g., a speech decoder (block 178).

If instead at diamond 165 it is determined that all of the data is not encoded, this implicitly means that instead all data is uncoded, as is the case for CS-4 logical channel data. Accordingly, control passes from diamond 165 to block 175. There, only the hard buffer may be deinterleaved (block 175). Then the deinterleaved symbols may be provided to the speech decoder (block 178).

Still referring to FIG. 5, if instead it is determined at diamond 160 that the data is partially encoded, control passes to block 180. There, the soft buffer may be deinterleaved (block 180). For example, in one embodiment the entire soft buffer may be deinterleaved. However, in other implementations, only the portion of the soft buffer corresponding to coded data may be deinterleaved. Next, the deinterleaved soft decisions may be decoded (block 185). As discussed above, a Viterbi decoding process may be performed. However, other decoding processes are also possible. Next, the hard buffer may be deinterleaved (block 190). Instead of deinterleaving the entire hard buffer however, in various implementations only the portion of the hard buffer corresponding to uncoded data may be deinterleaved. Accordingly, in implementations in which the entire soft buffer is first deinterleaved, the soft decisions determined above may be overwritten with the hard decisions for the non-coded data (block 192). Finally, the decoded symbols may be provided to a speech decoder for further processing (block 178). While described with these particular implementations, other manners of processing received data in a decoder may be performed.

Thus although in some implementations both the hard and soft decisions are deinterleaved in the decoder, computational complexity may be minimized. In different implementations, deinterleaving may take various forms, depending on the type of data to be decoded. As an example, all data in both hard and soft buffers may be deinterleaved. However, to reduce computation, not all bits are deinterleaved twice. Instead, only the uncoded bits may be deinterleaved from both the hard and soft buffers, with the deinterleaved decision from the soft buffer being overwritten by the hard decision.

The methods described herein may be implemented in software, firmware, and/or hardware. A software implementation may include an article in the form of a machine-readable storage medium onto which there are stored instructions and data that form a software program to perform such methods. As an example, a DSP may include instructions or may be programmed with instructions stored in a storage medium to perform equalization and decoding in accordance with an embodiment of the present invention.

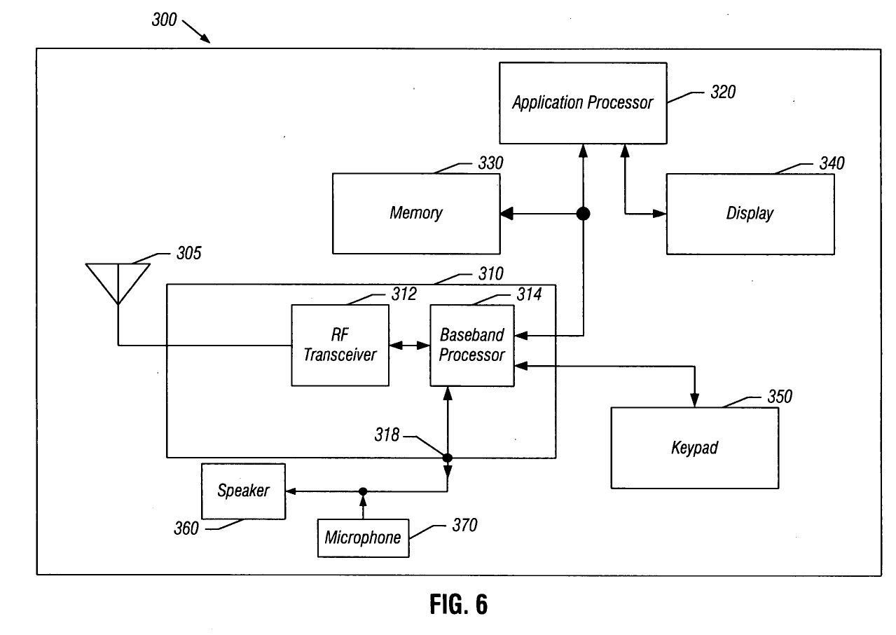

Referring now to FIG. 6, shown is a block diagram of a system in accordance with one embodiment of the present invention. As shown in FIG. 6, system 300 may be a wireless device, such as a cellular telephone, PDA, portable computer or the like. An antenna 305 is present to receive and transmit RF signals. Antenna 305 may receive different bands of incoming RF signals using an antenna switch. For example, a quad-band receiver may be adapted to receive GSM communications, enhanced GSM (EGSM), digital cellular system (DCS) and personal communication system (PCS) signals, although the scope of the present invention is not so limited. In other embodiments, antenna 305 may be adapted for use in a GPRS device, a satellite tuner, or a wireless local area network (WLAN) device, for example.

Incoming RF signals are provided to a transceiver 310 which may be a single chip transceiver including both RF components and baseband components. Transceiver 310 may be formed using a complementary metal-oxide-semiconductor (CMOS) process, in some embodiments. As shown in FIG. 6, transceiver 310 includes an RF transceiver 312 and a baseband processor 314. RF transceiver 312 may include receive and transmit portions and may be adapted to provide frequency conversion between the RF spectrum and a baseband. Baseband signals are then provided to a baseband processor 314 for further processing.

In some embodiments, transceiver 310 may correspond to ASIC 15 of FIG. 1. Baseband processor 314, which may correspond to DSP 10 of FIG. 1, may be coupled through a port 318, which in turn may be coupled to an internal speaker 360 to provide voice data to an end user. Port 318 also may be coupled to an internal microphone 370 to receive voice data from the end user.

After processing signals received from RF transceiver 312, baseband processor 314 may provide such signals to various locations within system 300 including, for example, an application processor 320 and a memory 330. Application processor 320 may be a microprocessor, such as a central processing unit (CPU) to control operation of system 300 and further handle processing of application programs, such as personal information management (PIM) programs, email programs, downloaded games, and the like. Memory 330 may include different memory components, such as a flash memory and a read only memory (ROM), although the scope of the present invention is not so limited. Additionally, a display 340 is shown coupled to application processor 320 to provide display of information associated with telephone calls and application programs, for example. Furthermore, a keypad 350 may be present in system 300 to receive user input.

Thus, in various embodiments an equalizer may generate both hard decisions and 2's complement soft decisions for all data bits, and a corresponding decoder deinterleaves data from either the soft buffer, hard buffer, or from both depending on the specific channel data. For a given performance level, embodiments may reduce computational complexity and memory usage for systems where the minimum precision of soft metrics is dictated by the bias term. Accordingly, embodiments of the present invention are computationally more efficient, as arithmetic operations may be performed without format conversion. Still further, reduced memory usage may be afforded, as the separate buffers allow reduced precision in storage of the soft metrics.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving channel data via a transmission channel;
generating a hard decision and a soft decision for each bit of the channel data in an equalizer; and
storing the hard decisions in a first buffer and storing the soft decisions in a second buffer.

2. The method of claim 1, further comprising quantizing each of the soft decisions before storing the soft decisions in the second buffer.

3. The method of claim 2, further comprising generating each of the hard decisions based on a corresponding unquantized soft decision.

4. The method of claim 2, further comprising storing the soft decisions in the second buffer in a two's complement representation.

5. The method of claim 1, further comprising decoding the channel data using the hard decisions and the soft decisions.

6. The method of claim 1, further comprising decoding the channel data using the hard decisions or the soft decisions.

7. The method of claim 6, further comprising using the soft decisions if the channel data is error coded.

8. The method of claim 6, further comprising using the hard decisions if the channel data is not error coded.

9. The method of claim 1, further comprising deinterleaving a first portion of the first buffer corresponding to a first portion of a radio block and deinterleaving a second portion of the second buffer corresponding to a second portion of the radio block.

10. The method of claim 9, wherein the first portion of the radio block is encoded and the second portion of the radio block is uncoded.

11. The method of claim 1, further comprising:
receiving radio frequency energy corresponding to a wireless burst in a mobile station;
demodulating the wireless burst into IQ data and buffering the IQ data until a wireless block is buffered; and
providing the buffered IQ data to the equalizer as the channel data.

12. An apparatus comprising:
an equalizer to generate hard decisions and soft decisions for incoming data received wirelessly;
a first buffer to store the hard decisions; and
a second buffer to store the soft decisions.

13. The apparatus of claim 12, wherein the equalizer is to generate each hard decision from a corresponding unquantized soft decision.

14. The apparatus of claim 13, wherein the equalizer is to generate the soft decisions in a 2's complement representation.

15. The apparatus of claim 12, further comprising a decoder coupled to the equalizer to decode the incoming data based on the hard decisions and the soft decisions.

16. The apparatus of claim 15, further comprising a digital signal processor (DSP) including the equalizer and the decoder.

17. The apparatus of claim 16, wherein the first buffer and the second buffer comprise a storage of the DSP.

18. The apparatus of claim 12, wherein the first buffer is sized to store the hard decisions for a predetermined number of symbols and the second buffer is sized to store the soft decisions for the predetermined number of symbols, wherein the second buffer size is at least double the first buffer size.

19. A mobile station comprising:
a digital signal processor (DSP) to receive baseband data and to process the baseband data, wherein the DSP is adapted to:
determine a soft decision for each of the baseband data and to determine a hard decision from the soft decision; and
decode at least one of the hard decision and the soft decision for each of the baseband data to generate a symbol corresponding to the baseband data;
radio frequency (RF) circuitry coupled to the DSP to receive incoming RF signals and provide the baseband data to the DSP; and
an antenna coupled to the RF circuitry to receive the incoming RF signals.

20. The mobile station of claim 19, wherein the DSP and the RF circuitry are at least in part integrated within the same integrated circuit.

21. The mobile station of claim 19, wherein the DSP is to store the hard decision as a single bit and to store the soft decision as a multi-bit 2's complement representation.

22. The mobile station of claim 21, wherein the DSP is to determine the hard decision before the soft decision is quantized for storage in the multi-bit 2's complement representation.

23. The mobile station of claim 19, wherein the DSP is to store the soft decision in a first buffer and the hard decision in a second buffer.

24. The mobile station of claim 23, wherein the DSP is to deinterleave the soft decisions in the first buffer for each of the baseband data and to further deinterleave the hard decisions in the second buffer only for each of the baseband data that is uncoded.

25. The mobile station of claim 23, wherein the DSP is to deinterleave only one of the soft decision in the first buffer or the hard decision in the second buffer for each of the baseband data.

26. The mobile station of claim 19, wherein the DSP is to decode the baseband data that is error coded using the soft decision and is to decode the baseband data that is not error coded using the hard decision.
